(19) United States
(12) Patent Application Publication
(10) Pub. No.: US 2025/0269990 A1
(43) Pub. Date: Aug. 28, 2025

(54) Shaping Antenna Radiation Patterns Via A Feed Cable

(71) Applicant: Skydio, Inc., San Mateo, CA (US)

(72) Inventors: Umar Hasni, Redwood City, CA (US); Eyal Hochdorf, Palo Alto, CA (US)

(21) Appl. No.: 19/066,257

(22) Filed: Feb. 28, 2025

Related U.S. Application Data
(60) Provisional application No. 63/558,871, filed on Feb. 28, 2024.

(51) Int. Cl. B64U 20/83; B64F 5/10; H01Q 1/28

(52) U.S. Cl. CPC B64U 20/83; B64F 5/10; H01Q 1/28

(57) ABSTRACT

Described herein are unmanned aerial vehicles (UAVs) and antenna assemblies thereof for shaping radiation patterns in wireless communication applications. For example, an embodiment pertains to an antenna assembly onboard an aerial vehicle. The antenna assembly includes a radiating element coupled to a chassis of an aerial vehicle, and a feed cable coupled to a portion of the radiating element and including a cable-shaping mechanism having a disposition in which a portion of the feed cable is placed and shaped diagonally a distance from the radiating element.

### CROSS-REFERENCE TO RELATED APPLICATION

This application claims priority to U.S. Provisional Patent Application No. 63/558,871 filed on Feb. 28, 2024, which is incorporated herein by reference in its entirety for all purposes.

### TECHNICAL FIELD

Various embodiments of the present technology relate to unmanned aerial vehicles (UAVs), and in particular, to antenna design thereof.

### BACKGROUND

Unmanned aerial vehicles (UAVs, e.g., drones) are useful for capturing videos, images, and other data from vantage points or access locations that would otherwise be difficult to reach. The flight, data-gathering, and other capabilities of a UAV can be controlled by an operator at a remote location, autonomously via control systems onboard the UAV, or in some combined manner. Commands and controls to operate the UAV are provided to the UAV via wireless communications established between an operator and the UAV. Data captured by the UAV during in-flight missions is returned to the operator also via the wireless communications.

Communication between the operator and the UAV are made possible by communication systems onboard the UAV that include various antennas and processors. To establish a wireless communication network with the operator, a UAV includes multiple antennas capable of transmitting and receiving data in specific frequency ranges based on a selected communication protocol (e.g., Wi-Fi). Each antenna includes a radiating element that, when powered, radiates energy to transmit or receive signals in the specific frequency ranges. The antennas also include feed cables capable of transferring signals between processors of the UAV and the respective radiating elements.

The operating characteristics (e.g., gain, efficiency) of the antennas are based not only on the quality, size, and design of the antennas, but also on the line-of-sight between the radiating elements and the operator. With respect to the design of the antennas, the feed cables are conductive elements often placed perpendicularly away from the radiating element so as to not impact the performance of the antennas. With respect to lines-of-sight, some elements of the UAV, such as the frame of the UAV, might reflect the radiation energy of the antennas. For example, reflection off different parts of the UAV may occur based on a given position of the UAV relative to the operator. When radiation is reflected by elements of the UAV, noise is produced in the signals received by the operator, which may cause issues with respect to the wireless communications between the operator and the UAV and ultimately reduce the efficiency of the antennas.

### OVERVIEW

An aerial vehicle is disclosed herein that includes an antenna assembly utilizing a shaped feed cable to affect radiation in certain directions. The disposition of the feed cable of the antenna assembly provides at least one or more benefits such as improving the gain of the antenna is desired directions to enhance transmission and reception capabilities of the antenna assembly with respect to the desired directions.

In an embodiment, an aerial vehicle is provided that includes a body, a plurality of rotor assemblies, a plurality of rotor arms, each rotor arm having a distal end, and a proximal end structurally coupled to the body and a rotor assembly of the plurality of rotor assemblies structurally coupled to the distal end, and an antenna assembly coupled to a rotor arm of the plurality of rotor arms. The antenna assembly includes a radiating element, and a feed cable coupled to a portion of the radiating element and including a cable-shaping mechanism having a disposition in which a portion of the feed cable is placed and shaped diagonally a distance from the radiating element.

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings.

FIG. 1 illustrates an exemplary operating architecture of an unmanned aerial vehicle in which some embodiments of the present technology may be utilized.

FIG. 2 illustrates aspects of an antenna assembly of an unmanned aerial vehicle in which some embodiments of the present technology may be utilized.

FIG. 3 illustrates aspects of an antenna assembly of an unmanned aerial vehicle in which some embodiments of the present technology may be utilized.

FIGS. 4A and 4B illustrate example radiation patterns produced by an antenna assembly of an unmanned aerial vehicle in which some embodiments of the present technology may be utilized.

FIG. 5 is a flowchart illustrating an exemplary process for manufacturing or assembly an antenna assembly in accordance with some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Technology is disclosed herein that mitigates the problems discussed with respect to antenna gain, efficiency, and radiation-shaping. In various embodiments, an aerial vehicle (e.g., unmanned aerial vehicle (UAV), e.g., drone) includes one or more antenna assemblies to enable wireless communication between the aerial vehicle and a remote receiver. An antenna assembly of the aerial vehicle includes a radiating element capable of producing energy with which to transmit and receive signals to and from the remote receiver, respectively, and a feed cable capable of transferring signals to and from the radiating element. Typically, the feed cable of an antenna is positioned in such a way that its effect on the operating characteristics (e.g., gain, efficiency, radiation pattern, frequency) of the radiating element is negligible. However, here, the feed cable is disposed such that a radiation pattern produced by the radiating element is shaped in certain directions, thus improving the antenna assemblies operating characteristics in at least the designated directions.

In various embodiments, a UAV includes a body or frame that supports a propulsion system for flight, one or more antenna assemblies for wireless communications, and a flight control system, among other systems and devices. The flight control system onboard the UAV communicates with a remote receiver using the antenna assemblies. The remote receiver can be a remote controller, a ground/docking station, a satellite, or the like. The propulsion system onboard the UAV is made up of propellors, motors, or the like, to fly the UAV. The flight control system is operatively coupled with the propulsion system to perform flight and navigation functions as directed by the remote receiver. Flight and navigation commands are provided to the remote receiver over a wireless communication network established between the remote receiver and the UAV. More specifically, such commands are transmitted by the remote receiver and received by the antenna assemblies of the UAV. Data captured during flight is transmitted to the remove receiver by the antenna assemblies.

The wireless communications are carried out in accordance with a wireless communication protocol (e.g., Wi-Fi, Bluetooth) and within specific frequency range(s) based on the wireless communication protocol. To transmit and receive signals to and from the remote receiver, the antenna assemblies include radiating elements that transmit and receive electromagnetic signals at specific frequencies. In some embodiments, the flight control system may select certain antennas for transmission or reception based on an antenna's line-of-sight with the receiver, and thus, an antenna's efficiency and gain with respect to a particular transmission or reception.

For example, during long-distance flight missions during which the UAV travels away from the remote receiver, it is important to be able to maintain effective and efficient communications with the UAV at long ranges. While in-flight traveling away from the remote receiver during such missions, the remote receiver may communicate with antenna assemblies located at the rear of the UAV. Conversely, while in-flight and traveling towards the remote receiver, the remote receiver may communicate with antenna assemblies located at the front of the UAV. Other elements of the UAV, such as components of the propulsion system or the body, however, may interfere with the antenna's line-of-sight. Such interference may limit the antenna's performance. It is with respect to the forward-facing and rear-facing directions that improvements to the antenna assemblies are made to produce increased radiation shaped in the forward-facing and rear-facing directions (with respect to the body of the UAV) to improve wireless communication when the UAV is positioned in such directions relative to the remote receiver despite such other interference with the antennas.

While many of the embodiments described herein relate to aerial vehicles, the antenna design and radiation-shaping techniques may be applicable to various other applications and devices, such as other types of vehicles and other types of antennas. Additionally, or instead, the antenna design and radiation-shaping techniques may be applicable to shape radiation patterns of antennas in other directions, including variations and combinations thereof.

In an embodiment, an aerial vehicle is provided that includes a body, a plurality of rotor assemblies, a plurality of rotor arms, each rotor arm having a distal end, and a proximal end structurally coupled to the body and a rotor assembly of the plurality of rotor assemblies structurally coupled to the distal end, and an antenna assembly coupled to a rotor arm of the plurality of rotor arms. The antenna assembly includes a radiating element and a feed cable coupled to a portion of the radiating element and including a cable-shaping mechanism having a disposition in which a portion of the feed cable is placed and shaped diagonally a distance from the radiating element.

In another embodiment, an antenna assembly is provided. The antenna assembly includes a radiating element and a feed cable coupled to a portion of the radiating element and including a cable-shaping mechanism having a disposition in which a portion of the feed cable is placed and shaped diagonally a distance from the radiating element.

In yet another embodiment, a method of manufacturing an antenna assembly is provided. The method includes affixing a radiating element of the antenna assembly to a top side of a circuit board having the top side, a bottom side, a left side, and a right side, affixing an end of a feed cable to a portion of the radiating element through the bottom side of the circuit board, and disposing a portion of the feed cable having a cable-shaping mechanism in a disposition such that the portion of the feed cable is placed and shaped diagonally a distance from radiating element.

In yet another embodiment, an aerial vehicle is provided. The aerial vehicle includes a body, a plurality of rotor assemblies, a plurality of rotor arms, each rotor arm having a distal end, and a proximal end structurally coupled to the body and a rotor assembly of the plurality of rotor assemblies structurally coupled to the distal end, and a processor. The processor is configured to receive, from an antenna assembly, a signal having shaped radiation in a forward direction of the aerial vehicle relative to the body, and in a rear direction of the aerial vehicle relative to the body based on a disposition of a feed cable of the antenna assembly in which a portion of the feed cable is placed and shaped diagonally a distance from a radiating element of the antenna assembly.

Advantageously, the UAV and corresponding antenna assemblies described herein provide improvements to communication systems, devices, and protocols currently employed. For example, the antenna assemblies are designed such that their gain is increased by approximately 3 dB in multiple directions for a 60-degree elevation plane at wireless communication frequency ranges, such as at 2.4 GHz and 5.8 GHz ranges. As such, the antenna assemblies can increase effectiveness and efficiency of signal transmission and reception within such ranges and directions, which may be advantageous for at least long-distance flight missions of UAVs.

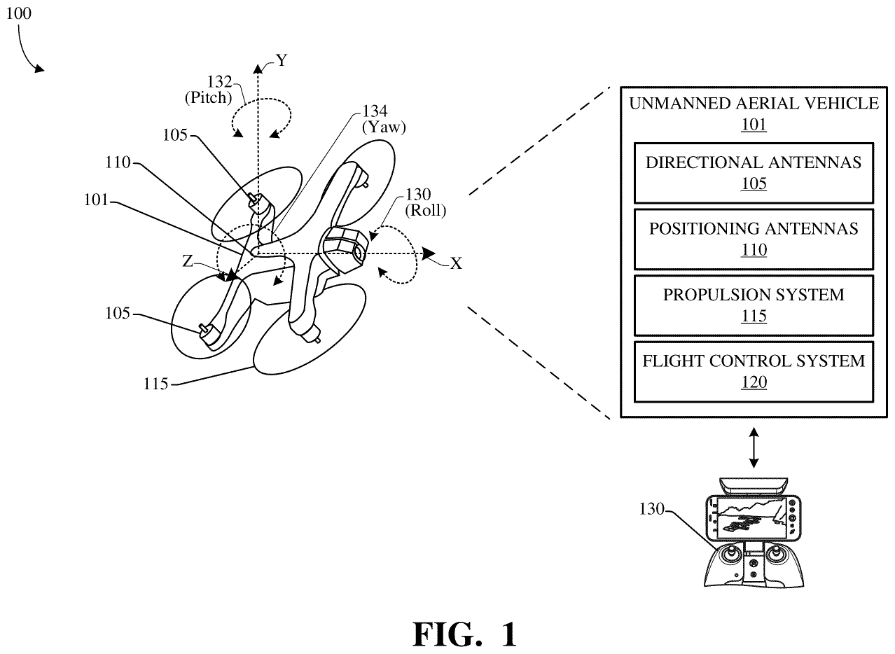

Turning now to the Figures, FIG. 1 illustrates an exemplary operating architecture 100 of an unmanned aerial vehicle (UAV) in which some embodiments of the present technology may be utilized. Operating architecture 100 includes UAV 101 and controller 130. UAV 101 is illustrated with respect to rotation terminology references including roll 130 which indicates a degree of rotation about the x-axis, pitch 132, which indicates a degree of rotation about the y-axis, and yaw 134, which indicates a degree of rotation about the z-axis.

As illustrated in operating architecture 100, UAV 101 comprises a body or frame, multiple directional antennas 105, one or more positioning antennas 110, a propulsion system 115, and a flight control system 120 directed to communicate with controller 130 via the directional antennas 105. In various embodiments, the body of UAV 101 includes a chassis internal to the body of UAV 101 that provides support for the body and for the various components of UAV 101. For example, directional antennas 105, positioning antennas 110, propulsion system 115, and flight control system 120 are affixed to portions of the chassis and/or to portions of the body.

Flight control system 120 is representative of a processing system that provides flight control, navigation, data collection, and other capabilities for UAV 101. In various embodiments, flight control system 120 includes one or more processors configured to enable such functionality via hardware, software, and firmware, as well as combinations and variations thereof. Examples of the processors of flight control system 120 includes one or more of central processing units (CPUs), graphical processing units (GPUs), general purpose processors, field-programmable logic arrays (FPGAs), application-specific integrated circuits (ASICs), digital signal processors (DSPs), and the like.

Flight control system 120 operates in remote communication with controller 130 via directional antennas 105 of UAV 101. In some implementations, controller 130 includes a mobile phone, tablet, or other computer running software configured to communicate with and control UAV 101. In other embodiments, controller 130 can be a stationary ground station or docking station comprising multiple antennas used to communicate with UAV 101. In a transmit mode, flight control system 120 provides one or more signals to controller 130 via a wireless communication network (e.g., Wi-Fi network, Bluetooth link) using directional antennas 105. These signals may include position or location information (e.g., Global Positioning System (GPS) data) captured by positioning antennas 110, images, videos, or other sensor data captured by sensors onboard UAV 101, and the like. In a receive mode, flight control system 120 receives one or more signals from controller 130 via the wireless communication network that issue a movement command of UAV 101 in an airspace. Upon receiving such signals, flight control system 120 can direct propulsion system 115 to maneuver to a specified target location, capture sensor data of a target, and the like.

Propulsion system 115 is representative of a system that provides flight capabilities of UAV 101. In various embodiments, propulsion system 115 includes propellors, motors, a propeller control system, rotor assemblies, rotor arms and the like. The rotor arms extend from the body of UAV 101 and include rotor assemblies and propellors affixed to top or bottom portions of the rotor arms. More specifically, each rotor arm includes a proximal end structurally coupled to the body of UAV 101, and a distal end extending away from the body to which a rotor assembly is structurally coupled.

In various embodiments, directional antennas 105 are also coupled to the rotor arms of propulsion system 115. In some embodiments, directional antennas 105 include four antenna assemblies, and each antenna assembly may be coupled to one of four rotor arms of UAV 101 either internally to the body of UAV, external to the body of UAV 101, or some combination thereof. Each antenna assembly includes a radiating element capable of producing energy to transmit signals (e.g., data) to controller 130 and receive signals (e.g., commands, controls) from controller 130, respectively. Each antenna assembly also includes a feed cable coupling the radiating element to flight control system 120. The feed cables of the antenna assemblies are utilized to provide received signals from controller 130 to flight control system 120, and to provide signals from flight control system 120 to be transmitted by the radiating element to controller 130.

In various embodiments, the feed cables include a cable-shaping mechanism to create a disposition of the feed cables relative to the radiating elements such that the feed cables contribute to the radiation pattern produced by the radiating elements. More specifically, the feed cables are shaped and placed diagonally a distance from a portion of the radiating element. More particularly, an outermost portion of a curved or bent feed cable (e.g., a vertex, apex, crest) is positioned diagonally relative to the portion of the radiating element. When signals are provided through the feed cables to the radiating elements, the feed cables introduce interference in the radiated energy from the radiating elements, and in turn, shape the radiation pattern produced by the radiating elements. In particular, the disposition of the feed cables creates a gain in forward direction of the antenna assemblies, and thus, the forward direction of UAV 101 (e.g., in the +x direction), as well as a gain the reverse direction of the antenna assemblies, and thus, the rear direction of UAV 101 (e.g., in the −x direction).

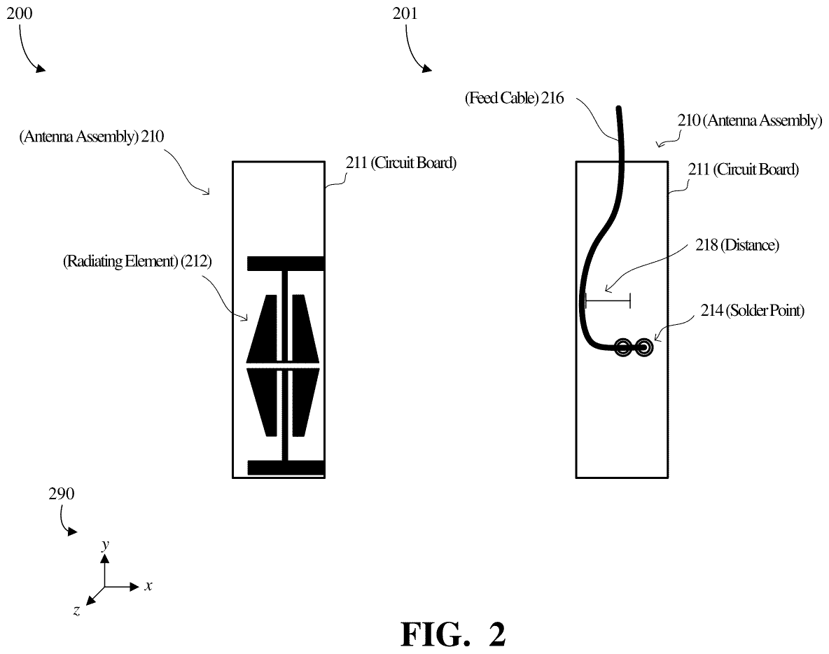

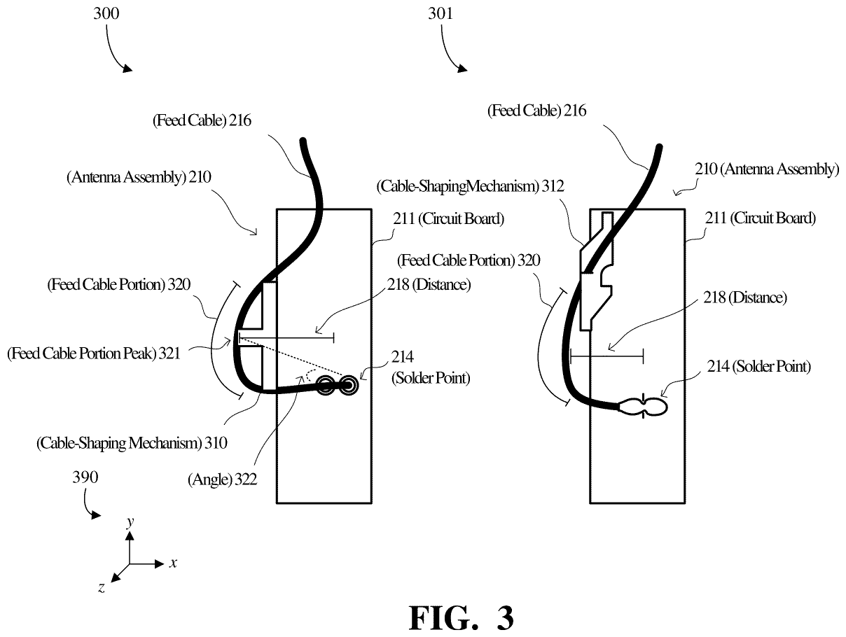

In operation of UAV 101, controller 130 transmits signals to UAV 101 to control flight maneuvers of UAV 101. Directional antennas 105 receive the signals from controller 130 and provide the signals to flight control system 120. Flight control system 120 receives a signal having shaped radiation in a forward direction of UAV 101 relative to the body (e.g., in the +x direction), and in a rear direction of UAV 101 relative to the body (e.g., in the −x direction) based on a disposition of a feed cable of an antenna assembly of directional antennas 105. In the disposition, a portion of the feed cable is placed and shaped diagonally a distance from a portion of the radiating element of the antenna assembly which shapes the radiation beams produced by directional antennas 105 used to receive the signals from controller 130. Additionally, during the operation of UAV 101, flight control system 120 provides signals to directional antennas 105 for transmission to controller 130. Upon transmission of the signals, controller 130 likewise receives signals having shaped radiation in the forward direction and the rear direction with respect to the body of UAV 101 based on the disposition of the feed cable of directional antennas 105. Examples of directional antennas 105 and corresponding feed cable dispositions are shown and described in further detail in FIGS. 2 and 3 below.

FIG. 2 illustrates aspects 200 and 201 of antenna assembly 210 of an unmanned aerial vehicle (e.g., UAV 101 of FIG. 1) in which some embodiments of the present technology may be utilized. In various embodiments, antenna assembly 210 is representative of one of directional antennas 105 of UAV 101. The following description of antenna assembly 210 is discussed with respect to axes 290.

Referring to aspects 200 and 201 interchangeably, aspect 200 shows a first side (e.g., a front side) of antenna assembly 210, while aspect 201 shows a second side (e.g., a back side) of antenna assembly 210 rotated 180 degrees about the y-axis relative to the first side. Antenna assembly 210 includes a radiating element 212 (shown in aspect 200) affixed to the first side of circuit board 211, and a feed cable 216 (shown in aspect 201) affixed to the second side of circuit board 211. Circuit board 211 may be a printed circuit board (PCB) including various layers, vias, dielectric materials, traces, and other components. In such examples, feed cable 216 is electrically coupled to radiating element 212 through one or more vias of circuit board 211. While not shown, an end of feed cable 216 may be coupled to a processing system, such as flight control system 120 of FIG. 1.

In various embodiments, radiating element 212 is affixed to circuit board 211 in a corner portion of circuit board 211. Feed cable 216 is affixed to circuit board 211 in a middle portion of circuit board 211, and in particular, to a middle portion of radiating element 212 at solder point 214. As shown in aspect 201, feed cable 216 has a disposition in which a first portion of feed cable 216 affixed to circuit board 211 at solder point 214 extends perpendicularly from radiating element 212 with respect to the y-axis, a second portion of feed cable 216 is placed and shaped a distance 218 from a vertical midline of radiating element 212 extending axially along the y-axis at the midpoint of radiating element 212 with respect to the x-axis, and a third portion of feed cable 216 extends in parallel with the radiating element with respect to the y-axis. In some embodiments, the second portion of feed cable 216 is shaped in a curved manner with the vertex of the curved portion extending distance 218 away from radiating element 212.

In operation of antenna assembly 210 (e.g., in transmit mode, in receive mode), radiating element 212 generates electromagnetic waves in several directions and of varying strengths (e.g., gain). With the disposition of feed cable 216 as shown in aspect 201, the second portion of feed cable 216 affects the pattern and the strength of the electromagnetic waves in certain directions so as to shape the amount of radiation output by radiating element 212. For example, the disposition of feed cable 216 increases the gain of the radiation produced by radiating element 212 in a forward direction with respect to the body of UAV 101 (e.g., in the +x direction with respect to FIG. 1) and the gain of the radiation produced by radiating element 212 in a rear direction with respect to the body of UAV 101 (e.g., in the-X direction with respect to FIG. 1). In this way, while an aerial vehicle that includes antenna assembly 210 travels away from and towards a remote receiver (e.g., controller 130 of FIG. 1), antenna assembly 210 may enable stronger and more efficient wireless communications than an antenna assembly with a different disposition. For example, in some embodiments, and in reference to the view of circuit board 211 in aspect 201, feed cable 216 has a different disposition in which feed cable 216 extends perpendicularly from circuit board 211 in the +z direction with respect to axes 290 (i.e., away from radiating element 212). With this different disposition, feed cable 216 might not affect the radiation pattern produced by radiating element 212.

In various embodiments, the radiation-shaping effect (e.g., gain improvement, direction selection, frequency selection) of feed cable 216 on radiating element 212 is based on distance 218, among other factors. In particular, to impact the radiation produced by radiating element 212 at its specific operating frequency, distance 218 is determined based on a multiple of the quarter-wavelength of radiating element 212 so that feed cable reflects radiation in the specific operating frequency in the forward and rear directions. Distance 218 may be determined using the following equation where d is equal to distance 218, and A is the wavelength of the operating frequency of radiating element 212:

d=¼*λ

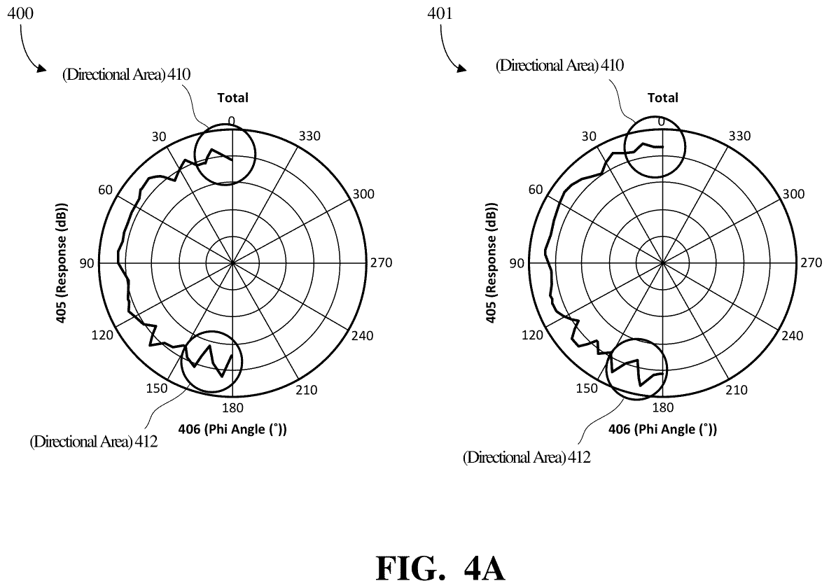

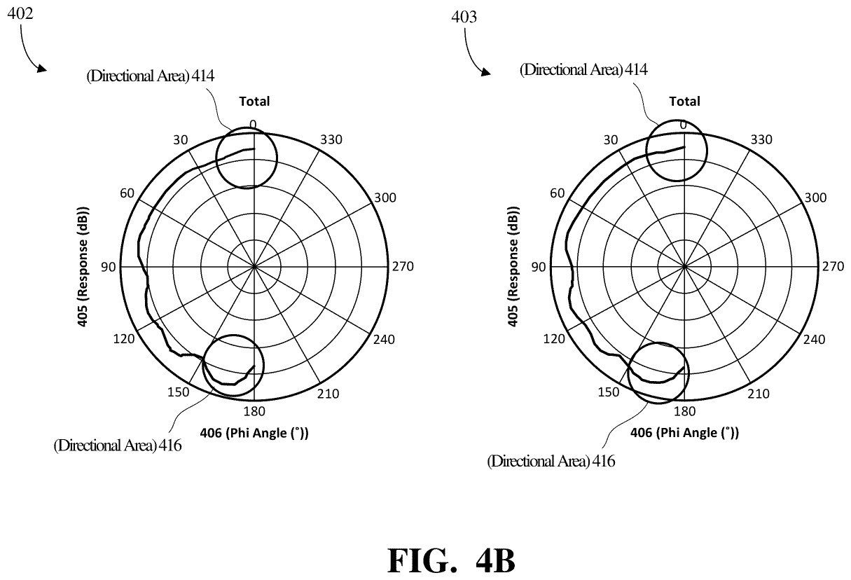

By way of example, for a radiating element with an operating frequency of 2.4 GHz (a Wi-Fi frequency band), the minimum distance, d, for effectuating constructive interference of the radiation pattern as described above is 3.125 centimeters. Antenna assembly 218 may produce radiation with a gain increase of 3 dB in the forward and rear directions with the disposition shown in aspect 201 relative to an antenna assembly with the different disposition. Example radiation patterns produced by antenna assemblies having the described disposition compared to the different disposition are shown in FIGS. 4A and 4B below.

For greater improvements in gain (e.g., 6 dB or more), feed cable 216 may be placed further away from radiating element 212. In such examples, distance 218 may be a distance approximately equal to a half-wavelength or one wavelength of the operating frequency of radiating element 212. Additionally, or instead, feed cable 216 may include a larger gauge cable that is thicker and wider based on the size and operating frequency of radiating element 212. Additionally, or instead, distance 218, as well as the dimensions, type, and curvature of feed cable 216 may be based on the material and size of radiating element 212.

In some embodiments, feed cable 216 has another different disposition such that the radiation of radiating element 212 is shaped in different directions other than the forward and rear directions of UAV 101. As such, several combinations and variations of feed cable 216, radiating element 212, and dispositions, dimensions, and distances thereof may impact the radiation pattern produced by antenna assembly 210.

Moving to FIG. 3, FIG. 3 illustrates aspects 300 and 301 of antenna assembly 210 of an unmanned aerial vehicle (e.g., UAV 101 of FIG. 1) in which some embodiments of the present technology may be utilized. In various embodiments, antenna assembly 210 is representative of one of directional antennas 105 of UAV 101. The following description of antenna assembly 210 is discussed with respect to axes 390.

Aspects 300 and 301 both show a top-down view of a side of antenna assembly 210. In particular, aspects 300 and 301 show a side of antenna assembly 210 on which feed cable 216 is affixed to circuit board 211. While not shown, a radiating element, such as radiating element 212, is affixed to the other side of circuit board 211 and coupled to feed cable 216 through one or more vias and electrical traces of circuit board 211.

Feed cable 216 is affixed to circuit board 211 in a middle portion of circuit board 211, and in particular, to a middle portion of radiating element 212 (not shown) at solder point 214. In both aspects 300 and 301, feed cable 216 has a disposition in which a first portion of feed cable 216 affixed to circuit board 211 at solder point 214 extends perpendicularly from radiating element 212 with respect to the y-axis, a second portion of feed cable 216, feed cable portion 320, is placed and shaped a distance 218 from a vertical midline of circuit board 211 extending axially along the y-axis at the midpoint of circuit board 211 with respect to the x-axis, and a third portion of feed cable 216 extends in parallel with the radiating element with respect to the y-axis. In some embodiments, the second portion of feed cable 216 is shaped in a curved manner with the vertex of the curved portion extending distance 218 away from radiating element 212.

In aspect 300, feed cable portion 320 is shaped and placed distance 218 from the radiating element by cable-shaping mechanism 310. More particularly, an outermost portion of a curved or bent portion of feed cable 216 (i.e., feed cable portion peak 321 of feed cable portion 320) is positioned diagonally relative to solder point 214. Feed cable portion peak 321 is positioned at angle 322 from solder point 214 with respect to the x-axis and at distance 218 from solder point 214. Distance 218 includes a horizontal distance between feed cable portion peak 321 and solder point 214 with respect to axes 390.

In some embodiments, cable-shaping mechanism 310 includes a bracket affixed to circuit board 211 and to which portions of feed cable 216 are affixed. In some embodiments, cable-shaping mechanism 310 is part of feed cable 216. In other words, cable-shaping mechanism 310 is part of the shielding or exterior of feed cable 216. In some embodiments, cable-shaping mechanism 310 is an extension of feed cable 216 manufactured with feed cable 216.

In aspect 301, feed cable portion 320 is shaped and placed distance 218 from the radiating element by cable-shaping mechanism 312. In some embodiments, cable-shaping mechanism 312 includes a bracket affixed to circuit board 211 and to which portions of feed cable 216 are affixed. Cable-shaping mechanism 312 may be affixed to a different portion of circuit board 211, and/or different portions of feed cable 216 may be affixed to cable-shaping mechanism 312. In some embodiments, cable-shaping mechanism 312 is part of feed cable 216. In other words, cable-shaping mechanism 312 is part of the shielding or exterior of feed cable 216. In some embodiments, cable-shaping mechanism 312 is an extension of feed cable 216 manufactured with feed cable 216.

Regardless of the type, material, or placement of the cable-shaping mechanism, both cable-shaping mechanisms helps dispose feed cable portion 320 a distance 218 from the radiating element. As such, the dimensions of cable-shaping mechanisms 310 and 312, as well as the placement of cable-shaping mechanisms 310 and 312 relative to circuit board 211 are based on distance 218. In this way, feed cable portion 320 of feed cable 216 affects the pattern and the strength of the electromagnetic waves in certain directions so as to shape the amount of radiation output by the radiating element. For example, the disposition of feed cable 216 increases the gain of the radiation produced by the radiating element in a forward direction with respect to the body of UAV 101 (e.g., in the +x direction with respect to FIG. 1) and the gain of the radiation produced by the radiating element in a rear direction with respect to the body of UAV 101 (e.g., in the −x direction with respect to FIG. 1). In this way, while an aerial vehicle that includes antenna assembly 210 travels away from and towards a remote receiver (e.g., controller 130 of FIG. 1), antenna assembly 210 may enable stronger and more efficient wireless communications than an antenna assembly with a different disposition. For example, in some embodiments, and in reference to the view of circuit board 211 in aspect 300 or 301, feed cable 216 has a different disposition in which feed cable 216 extends perpendicularly from circuit board 211 in the +z direction with respect to axes 390 (i.e., away from the radiating element and out of the page towards a viewer of FIG. 3). With this different disposition, feed cable 216 might not affect the radiation pattern produced by the radiating element.

In various embodiments, the radiation-shaping effect (e.g., gain improvement, direction selection, frequency selection) of feed cable 216 on the radiating element is based on distance 218, among other factors. In particular, to impact the radiation produced by radiating element 212 at its specific operating frequency, distance 218 is determined based on a multiple of the quarter-wavelength of the radiating element so that feed cable reflects radiation in the specific operating frequency in the forward and rear directions. Distance 218 may be determined using the following equation where d is equal to distance 218, and A is the wavelength of the operating frequency of the radiating element:

d=¼*λ

By way of example, for a radiating element with an operating frequency of 2.4 GHz (i.e., a Wi-Fi frequency band), the minimum distance, d, for effectuating constructive interference of the radiation pattern as described above is 3.125 centimeters. Antenna assembly 218 may produce radiation with a gain increase of 3 dB in the forward and rear directions with the disposition shown in aspect 201 relative to an antenna assembly with the different disposition. Example radiation patterns produced by antenna assemblies having the described disposition compared to the different disposition are shown in FIGS. 4A and 4B below.

Referring now to FIGS. 4A and 4B, FIGS. 4A and 4B illustrate example radiation patterns produced by an antenna assembly of an unmanned aerial vehicle in which some embodiments of the present technology may be utilized. FIG. 4A includes graphical representations 400 and 401, and FIG. 4B includes graphical representations 402 and 403.

Referring first to FIG. 4A, graphical representations 400 and 401 show radiation patterns produced by an antenna assembly operating in a 5.8 GHz frequency band with respect to response 405 and phi angle 406. In particular, graphical representation 400 shows a radiation pattern produced by an antenna with a feed cable having a disposition such that the effect of the feed cable on the radiation produced by the radiating element of the antenna assembly is negligible (e.g., the “different disposition” as described above in FIG. 2 and FIG. 3). Contrarily, graphical representation 401 shows a radiation pattern produced by an antenna assembly with a feed cable having a disposition such that the feed cable contributes to the radiation produced by the radiating element, and thus, influences the operating characteristics of the antenna assembly in at least two directions, such as antenna assembly 210 with feed cable 216 having the disposition shown in FIGS. 2 and 3.

As shown in aspect 401, the radiation pattern is less noisy, and thus, has a higher gain in directional areas 410 and 412 relative to the radiation pattern shown in aspect 400. Directional area 410 represents a near-zero-degree phi angle 406, or in other words, a forward direction relative to a body of an aerial vehicle (e.g., the +X direction of UAV 101 of FIG. 1). Directional area 412 represents a near −180 degree phi angle 406, or in other words, a rear direction relative to a body of an aerial vehicle (e.g., the −X direction of UAV 101 of FIG. 1).

Referring next to FIG. 4B, graphical representations 402 and 403 show radiation patterns produced by an antenna assembly operating in a 2.4 GHz frequency band with respect to response 405 and phi angle 406. In particular, graphical representation 402 shows a radiation pattern produced by an antenna with a feed cable having a disposition such that the effect of the feed cable on the radiation produced by the radiating element of the antenna assembly is negligible (e.g., the “different disposition” as described above in FIG. 2 and FIG. 3). Contrarily, graphical representation 403 shows a radiation pattern produced by an antenna assembly with a feed cable having a disposition such that the feed cable contributes to the radiation produced by the radiating element, and thus, influences the operating characteristics of the antenna assembly in at least two directions, such as antenna assembly 210 with feed cable 216 having the disposition shown in FIGS. 2 and 3.

As shown in aspect 403, the radiation pattern is less noisy, and thus, has a higher gain in directional areas 410 and 412 relative to the radiation pattern shown in aspect 402. Directional area 410 represents a near-zero-degree phi angle 406, or in other words, a forward direction relative to a body of an aerial vehicle (e.g., the +x direction of UAV 101 of FIG. 1). Directional area 412 represents a near −180 degree phi angle 406, or in other words, a rear direction relative to a body of an aerial vehicle (e.g., the −x direction of UAV 101 of FIG. 1).

Advantageously, when using the feed cable to influence the radiation produced by the radiating element of the antenna assembly as shown in aspects 401 and 403, a remote receiver may be able to more effectively and efficiently transmit and receive signals to and from the antenna assembly, respectively, in the zero-degree and 180-degrees directions. This may be advantageous in the context of aerial vehicle missions as communication to and from aerial vehicles is constrained by power and frequency regulations. When the aerial vehicles fly further away from a remote receiver (at 180-degree phi angles), and when aerial vehicles return from far distances and fly back towards the remote receiver (at zero-degree phi angles), such a disposition of the feed cable can improve communication strength and efficiency and combat regulations and other interference caused by other devices and structures between the aerial vehicle and the remote receiver.

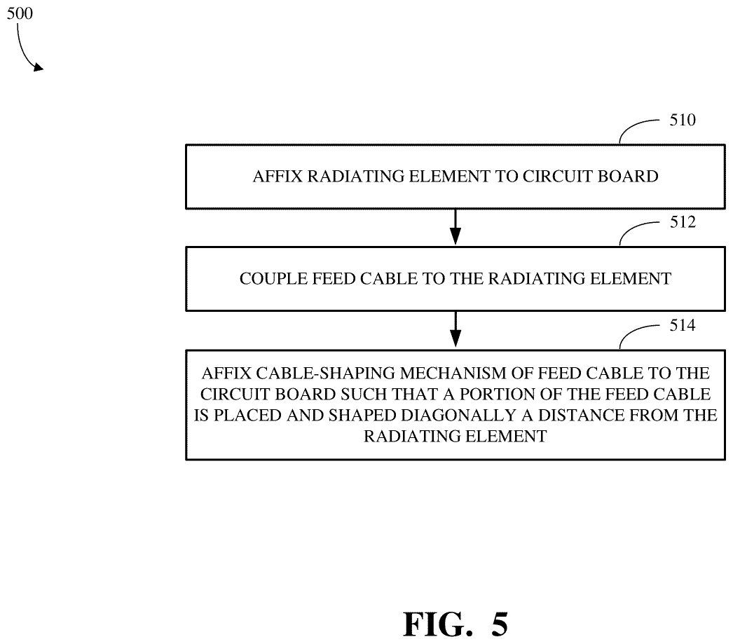

FIG. 5 is a flowchart illustrating an exemplary process for manufacturing or assembly an antenna assembly in accordance with some embodiments of the present technology. FIG. 5 includes method 500, which includes various steps to assemble elements of an antenna assembly and affix the antenna assembly to an aerial vehicle, referring to the steps of method 500 parenthetically below. More specifically, method 500 can be implemented to assembly directional antennas 105 of UAV 101 and antenna assembly 210 of FIGS. 2 and 3 of UAV 101 of FIG. 1.

Method 500 includes affixing (510) (e.g., attaching, coupling, soldering, or otherwise physically and/or electrically coupling) a radiating element to a circuit board. The radiating element of the antenna assembly is representative of a conductive plate capable of converting electrical energy into electromagnetic waves for transmission and reception of signals at specific operating frequencies. The radiating element may be affixed to a layer of the circuit board (e.g., a PCB). The circuit board may include various other electrical and conductive elements, traces, vias, and the like.

Method 500 also includes coupling (512) a feed cable of the antenna assembly to the radiating element. In various embodiments, the feed cable is representative of a conductive cable for transferring signals to the radiating element for transmission thereof and for receiving signals from the radiating element for use by a processing system (e.g., flight control system 120 of FIG. 1). The feed cable may be affixed to the circuit board, such as by soldering the feed cable to a solder point on the circuit board. Then, the feed cable may be electrically coupled to the radiating element through one or more electrical traces and vias of the circuit board.

Next, method 500 includes affixing (514) a cable-shaping mechanism of the feed cable to the circuit board. The cable-shaping mechanism may be a bracket, a brace, or some other connection mechanism used to shape the feed cable about the circuit board. In some embodiments, the cable-shaping mechanism may be a part of the feed cable. In some embodiments, the cable-shaping mechanism may be an additional component separate from the feed cable and affixed to both the feed cable and the circuit board.

Affixing the cable-shaping mechanism to the circuit board may entail disposing the feed cable in such a manner as to place and shape a portion of the feed cable diagonally a distance from a center portion of the radiating element. Examples of such a disposition are illustrated and described in FIGS. 2 and 3 above. In such a disposition, the feed cable can interfere with, reflect, or otherwise impact the radiation produced by the radiating element in one or more directions. For example, the feed cable may be disposed a quarter-wavelength, diagonal distance from the center of the radiating element, which may increase the gain of the radiating element in two directions 180-degrees out-of-phase relative to one another (e.g., a forward direction and a rear direction 180-degrees from the forward direction). Advantageously, such an assembly of the antenna assembly may result in improved wireless communication between a remote receiver and the antenna assembly in at least the two directions.

Disclosed herein are implementations of the described improvement in the context of aerial vehicles.

In a first aspect, the subject matter described in this specification can be embodied in systems that include an aerial vehicle comprising: a body, a plurality of rotor assemblies, a plurality of rotor arms, each rotor having a distal end, and a proximal end structurally coupled to the body and a rotor assembly of the plurality of rotor assemblies structurally coupled to the distal end, and an antenna assembly coupled to a rotor arm of the plurality of rotor arms, wherein the antenna assembly comprises: a radiating element, and a feed cable coupled to a portion of the radiating element and including a cable-shaping mechanism having a disposition in which a portion of the feed cable is placed and shaped diagonally a distance from the radiating element.

In a second aspect, the subject matter described in this specification can be embodied in systems that include the aerial vehicle of the preceding aspect, wherein, based on the disposition of the cable-shaping mechanism, the radiating element of the antenna assembly creates a signal having shaped radiation in a forward direction of the aerial vehicle relative to the body, and in a rear direction of the aerial vehicle relative to the body.

In a third aspect, the subject matter described in this specification can be embodied in systems that include the aerial vehicle of the preceding aspect(s), wherein the cable-shaping mechanism has a mirrored disposition relative to the disposition, and wherein, based on the mirrored disposition, the radiating element of the antenna assembly creates a mirrored signal having shaped radiation of an opposite direction relative to the signal in a forward direction of the aerial vehicle relative to the body, and in a rear direction of the aerial vehicle relative to the body.

In a fourth aspect, the subject matter described in this specification can be embodied in systems that include the aerial vehicle of the preceding aspect(s), wherein the aerial vehicle further comprises a processor coupled to the antenna assembly via the feed cable and configured to receive a signal having shaped radiation in a forward direction of the aerial vehicle relative to the body, and in a rear direction of the aerial vehicle relative to the body.

In a fifth aspect, the subject matter described in this specification can be embodied in systems that include the aerial vehicle of the preceding aspect(s), wherein, the cable-shaping mechanism has a different disposition relative to the disposition; in the different disposition, the portion of the feed cable is placed and shaped axially away from the radiating element; and based on the different disposition, the radiating element of the antenna assembly creates a signal having radiation irrespective of the feed cable.

In a sixth aspect, the subject matter described in this specification can be embodied in systems that include the aerial vehicle of the preceding aspect(s), wherein the distance between the feed cable and the radiating element is based on a multiple of a quarter-wavelength of a frequency of the radiating element.

In a seventh aspect, the subject matter described in this specification can be embodied in systems that include the aerial vehicle of the preceding aspect(s), wherein the portion of the feed cable shaped by the cable-shaping mechanism is a first portion; the distance between the first portion and the radiating element is a first distance; and based on the disposition: a second portion of the feed cable coupled to the portion of the radiating element extends perpendicularly relative to a first axis a second distance from the portion of the radiating element, a third portion of the feed cable between the first and second portions is curved at least partially in parallel along the first axis; and a fourth portion of the feed cable including at least a subset of a remainder of the feed cable extends in parallel relative to the first axis a third distance from the portion of the radiating element.

In an eighth aspect, the subject matter described in this specification can be embodied in systems that include the aerial vehicle of the preceding aspect(s), wherein a length and a thickness of the feed cable are based on a frequency range of the radiating element.

In a ninth aspect, the subject matter described in this specification can be embodied in systems that include an antenna assembly comprising: a radiating element, and a feed cable coupled to a portion of the radiating element and including a cable-shaping mechanism having a disposition in which a portion of the feed cable is placed and shaped diagonally a distance from the radiating element.

In a tenth aspect, the subject matter described in this specification can be embodied in systems that include the antenna assembly of the preceding aspect, wherein the antenna assembly is affixed to an aerial vehicle including a body, a plurality of rotor assemblies, and a plurality of rotor arms, each rotor arm having a distal end, and a proximal end structurally coupled to the body and a rotor assembly of the plurality of rotor assemblies structurally coupled to the distal end.

In an eleventh aspect, the subject matter described in this specification can be embodied in systems that include the antenna assembly of the preceding aspect(s), wherein, based on the disposition of the cable-shaping mechanism, during an operation of the antenna assembly, the radiating element of the antenna assembly creates a signal having shaped radiation in a forward direction of the aerial vehicle relative to the body, and in a rear direction of the aerial vehicle relative to the body.

In a twelfth aspect, the subject matter described in this specification can be embodied in systems that include the antenna assembly of the preceding aspect(s), wherein the cable-shaping mechanism has a mirrored disposition relative to the disposition, and wherein, based on the mirrored disposition, during the operation of the antenna assembly, the radiating element of the antenna assembly creates a mirrored signal having shaped radiation of an opposite direction relative to the signal in a forward direction of the aerial vehicle relative to the body, and in a rear direction of the aerial vehicle relative to the body.

In a thirteenth aspect, the subject matter described in this specification can be embodied in systems that include the antenna assembly of the preceding aspect(s), wherein the cable-shaping mechanism has a different disposition relative to the disposition; in the different disposition, the portion of the feed cable is placed and shaped axially away from the radiating element; and based on the different disposition, during an operation of the antenna assembly, the radiating element of the antenna assembly creates a signal having radiation irrespective of the feed cable.

In a fourteenth eleventh aspect, the subject matter described in this specification can be embodied in systems that include the antenna assembly of the preceding aspect(s), wherein the distance between the feed cable and the radiating element is based on a multiple of a quarter-wavelength of a frequency of the radiating element.

In a fifteenth aspect, the subject matter described in this specification can be embodied in systems that include the antenna assembly of the preceding aspect(s), wherein: the portion of the feed cable shaped by the cable-shaping mechanism is a first portion; the distance between the first portion and the radiating element is a first distance; and based on the disposition: a second portion of the feed cable coupled to the portion of the radiating element extends perpendicularly relative to a first axis a second distance from the portion of the radiating element, a third portion of the feed cable between the first and second portions is curved at least partially in parallel along the first axis; and a fourth portion of the feed cable including at least a subset of a remainder of the feed cable extends in parallel relative to the first axis a third distance from the portion of the radiating element.

In an sixteenth aspect, the subject matter described in this specification can be embodied in systems that include the antenna assembly of the preceding aspect(s), wherein a length and a thickness of the feed cable are based on a frequency range of the radiating element.

In a seventeenth aspect, the subject matter described in this specification can be embodied in methods of manufacturing or assembling of an antenna assembly comprising: affixing a radiating element of the antenna assembly to a top side of a circuit board having the top side, a bottom side, a left side, and a right side, affixing an end of a feed cable to a portion of the radiating element through the bottom side of the circuit board, and disposing a portion of the feed cable having a cable-shaping mechanism in a disposition such that the portion of the feed cable is placed and shaped diagonally a distance from radiating element.

In an eighteenth aspect, the subject matter described in this specification can be embodied in methods of the preceding aspect, wherein the distance between the feed cable and the radiating element is based on a multiple of a quarter-wavelength of a frequency of the radiating element.

In a nineteenth aspect, the subject matter described in this specification can be embodied in methods of the preceding aspect(s), wherein a length and a thickness of the feed cable are based on the frequency of the radiating element.

In a twentieth aspect, the subject matter described in this specification can be embodied in methods of the preceding aspect(s), wherein the method further comprises: coupling another end of the feed cable to a processor; and transmitting a signal having shaped radiation in one or more directions based on the disposition of the cable-shaping mechanism.

In a twenty-first aspect, the subject matter described in this specification can be embodied in systems that include an aerial vehicle comprising: a body, a plurality of rotor assemblies, a plurality of rotor arms, each rotor arm having a distal end, and a proximal end structurally coupled to the body and a rotor assembly of the plurality of rotor assemblies structurally coupled to the distal end, and a processor configured to receive, from an antenna assembly, a signal having shaped radiation in a forward direction of the aerial vehicle relative to the body, and in a rear direction of the aerial vehicle relative to the body based on a disposition of a feed cable of the antenna assembly in which a portion of the feed cable is placed and shaped diagonally a distance from a radiating element of the antenna assembly.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. An aerial vehicle, comprising:
a body;
a plurality of rotor assemblies;
a plurality of rotor arms, each rotor arm having a distal end, and a proximal end structurally coupled to the body and a rotor assembly of the plurality of rotor assemblies structurally coupled to the distal end; and
an antenna assembly coupled to a rotor arm of the plurality of rotor arms, wherein the antenna assembly comprises:
a radiating element; and
a feed cable coupled to a portion of the radiating element and including a cable-shaping mechanism having a disposition in which a portion of the feed cable is placed and shaped diagonally a distance from the radiating element.

2. The aerial vehicle of claim 1, wherein, based on the disposition of the cable-shaping mechanism, the radiating element of the antenna assembly creates a signal having shaped radiation in a forward direction of the aerial vehicle relative to the body, and in a rear direction of the aerial vehicle relative to the body.

3. The aerial vehicle of claim 2, wherein the cable-shaping mechanism has a mirrored disposition relative to the disposition, and wherein, based on the mirrored disposition, the radiating element of the antenna assembly creates a mirrored signal having shaped radiation of an opposite direction relative to the signal in a forward direction of the aerial vehicle relative to the body, and in a rear direction of the aerial vehicle relative to the body.

4. The aerial vehicle of claim 1, further comprising a processor coupled to the antenna assembly via the feed cable and configured to receive a signal having shaped radiation in a forward direction of the aerial vehicle relative to the body, and in a rear direction of the aerial vehicle relative to the body.

5. The aerial vehicle of claim 1, wherein:
the cable-shaping mechanism has a different disposition relative to the disposition;
in the different disposition, the portion of the feed cable is placed and shaped axially away from the radiating element; and
based on the different disposition, the radiating element of the antenna assembly creates a signal having radiation irrespective of the feed cable.

6. The aerial vehicle of claim 1, wherein the distance between the feed cable and the radiating element is based on a multiple of a quarter-wavelength of a frequency of the radiating element.

7. The aerial vehicle of claim 1, wherein:
the portion of the feed cable shaped by the cable-shaping mechanism is a first portion;
the distance between the first portion and the radiating element is a first distance; and
based on the disposition:
a second portion of the feed cable coupled to the portion of the radiating element extends perpendicularly relative to a first axis a second distance from the portion of the radiating element,
a third portion of the feed cable between the first and second portions is curved at least partially in parallel along the first axis; and
a fourth portion of the feed cable including at least a subset of a remainder of the feed cable extends in parallel relative to the first axis a third distance from the portion of the radiating element.

8. The aerial vehicle of claim 1, wherein a length and a thickness of the feed cable are based on a frequency range of the radiating element.

9. An antenna assembly comprising:
a radiating element; and a
a feed cable coupled to a portion of the radiating element and including a cable-shaping mechanism having a disposition in which a portion of the feed cable is placed and shaped diagonally a distance from the radiating element.

10. The antenna assembly of claim 9, wherein the antenna assembly is affixed to an aerial vehicle including a body, a plurality of rotor assemblies, and a plurality of rotor arms, each rotor arm having a distal end, and a proximal end structurally coupled to the body and a rotor assembly of the plurality of rotor assemblies structurally coupled to the distal end.

11. The antenna assembly of claim 10, wherein, based on the disposition of the cable-shaping mechanism, during an operation of the antenna assembly, the radiating element of the antenna assembly creates a signal having shaped radiation in a forward direction of the aerial vehicle relative to the body, and in a rear direction of the aerial vehicle relative to the body.

12. The antenna assembly of claim 11, wherein the cable-shaping mechanism has a mirrored disposition relative to the disposition, and wherein, based on the mirrored disposition, during the operation of the antenna assembly, the radiating element of the antenna assembly creates a mirrored signal having shaped radiation of an opposite direction relative to the signal in a forward direction of the aerial vehicle relative to the body, and in a rear direction of the aerial vehicle relative to the body.

13. The antenna assembly of claim 9, wherein:
the cable-shaping mechanism has a different disposition relative to the disposition;
in the different disposition, the portion of the feed cable is placed and shaped axially away from the radiating element; and
based on the different disposition, during an operation of the antenna assembly, the radiating element of the antenna assembly creates a signal having radiation irrespective of the feed cable.

14. The antenna assembly of claim 9, wherein the distance between the feed cable and the radiating element is based on a multiple of a quarter-wavelength of a frequency of the radiating element.

15. The antenna assembly of claim 9, wherein:
the portion of the feed cable shaped by the cable-shaping mechanism is a first portion;
the distance between the first portion and the radiating element is a first distance; and
based on the disposition:
a second portion of the feed cable coupled to the portion of the radiating element extends perpendicularly relative to a first axis a second distance from the portion of the radiating element,
a third portion of the feed cable between the first and second portions is curved at least partially in parallel along the first axis; and
a fourth portion of the feed cable including at least a subset of a remainder of the feed cable extends in parallel relative to the first axis a third distance from the portion of the radiating element.

16. The antenna assembly of claim 9, wherein a length and a thickness of the feed cable are based on a frequency range of the radiating element.

17. A method of manufacturing an antenna assembly, the method comprising:
affixing a radiating element of the antenna assembly to a top side of a circuit board having the top side, a bottom side, a left side, and a right side;
affixing an end of a feed cable to a portion of the radiating element through the bottom side of the circuit board; and
disposing a portion of the feed cable having a cable-shaping mechanism in a disposition such that the portion of the feed cable is placed and shaped diagonally a distance from radiating element.

18. The method of claim 17, wherein the distance between the feed cable and the radiating element is based on a multiple of a quarter-wavelength of a frequency of the radiating element.

19. The method of claim 18, wherein a length and a thickness of the feed cable are based on the frequency of the radiating element.

20. The method of claim 17. further comprising:
coupling another end of the feed cable to a processor; and
transmitting a signal having shaped radiation in one or more directions based on the disposition of the cable-shaping mechanism.
